(19) United States
(12) Patent Application Publication
(10) Pub. No.: US 2011/0304809 A1
(43) Pub. Date: Dec. 15, 2011

(54) ACTIVE MATRIX SUBSTRATE AND DISPLAY DEVICE

(75) Inventors: Hijiri Nakahara, Osaka-shi (JP); Junichi Morinaga, Osaka-shi (JP)

(73) Assignee: SHARP KABUSHIKI KAISHA, Osaka-shi, Osaka (JP)

(21) Appl. No.: 13/147,808

(22) PCT Filed: Nov. 13, 2009
(86) PCT No.: PCT/JP2009/069378

§ 371 Date: Aug. 4, 2011

(30) Foreign Application Priority Data
Mar. 18, 2009 (JP) 2009-066009

(51) Int. Cl. G02F 1/1343

(52) U.S. Cl. 349/143

(57) ABSTRACT

An active matrix substrate (5) serving as a substrate for a liquid crystal panel (display panel) (2) and comprising a plurality of source wiring lines (data wiring lines) (S) and a plurality of gate wiring lines (scanning wiring lines) (G) arranged in a matrix-like configuration along with thin film transistors (switching elements) (25) provided in the vicinity of the intersections between the source wiring lines (S) and gate wiring lines (G) and pixels (P) having pixel electrodes (26) connected to the thin film transistors (25). The active matrix substrate comprises a base material (5a) provided to permit mutual intersection between the source wiring lines (S) and gate wiring lines (G), and light shielding blocks (30) that shield the edge portions (26a, 26b) of two adjacent pixel electrodes (26) from light are provided on the base material (5a).

### TECHNICAL FIELD

The present invention relates to an active matrix substrate having a plurality of data wiring lines and a plurality of scanning wiring lines arranged thereon in a matrix-like configuration, as well as to a display device utilizing the same.

### BACKGROUND ART

In recent years, liquid crystal display devices have been widely used in LCD televisions, monitors, cellular phones, etc. as flat panel displays that possess the advantages of being thinner, lighter, etc. than ordinary cathode ray tubes. Well-known among such liquid crystal display devices are devices that utilize active matrix substrates for liquid crystal panels used as display panels. In these active matrix substrates, a plurality of data wiring lines (source wiring lines) and a plurality of scanning wiring lines (gate wiring lines) are wired in a matrix-like configuration and, in addition, thin film transistors (TFTs: Thin Film Transistors) and other switching elements, along with pixels having pixel electrodes connected to the switching elements, are disposed in a matrix-like configuration in the vicinity of the intersections between the data wiring lines and scanning wiring lines.

Further, in order to meet the demand for higher-resolution liquid crystal panels, the pixel aperture ratio in such active matrix substrates needs to be improved.

In recent years, it has been proposed that, as a means for improving the pixel aperture ratio, the conventional active matrix substrate should be provided with two auxiliary capacitance wiring lines on both sides of the data wiring lines and, in addition, pixel electrodes should be disposed over the auxiliary capacitance wiring lines so as to cover them, as described, for example, in Patent Document 1 listed below. In addition, it has been believed that in this conventional active matrix substrate capacitive coupling between the data wiring lines and the auxiliary capacitance electrodes provided facing a portion of the pixel electrodes can be reduced without decreasing the aperture ratio.

### CITATION LIST

### Patent Documents

Patent Document 1 JP H10-260430A

### DISCLOSURE OF INVENTION

### Problem to be Solved by the Invention

Incidentally, in order to prevent light leakage from spaces between two adjacent pixels in conventional active matrix substrates such as the one described above, a black matrix was usually provided above the above-described two pixels in order to cover the edge portions of these pixels with respect to an opposing substrate disposed facing the active matrix substrate.

However, a problem that arose in connection with conventional active matrix substrates such as the one described above was that the dimensions of the black matrix had to be increased in order to shield the spaces between the data wiring lines and the two auxiliary capacitance wiring lines from light, which made it difficult to improve the pixel aperture ratio in high-definition panels.

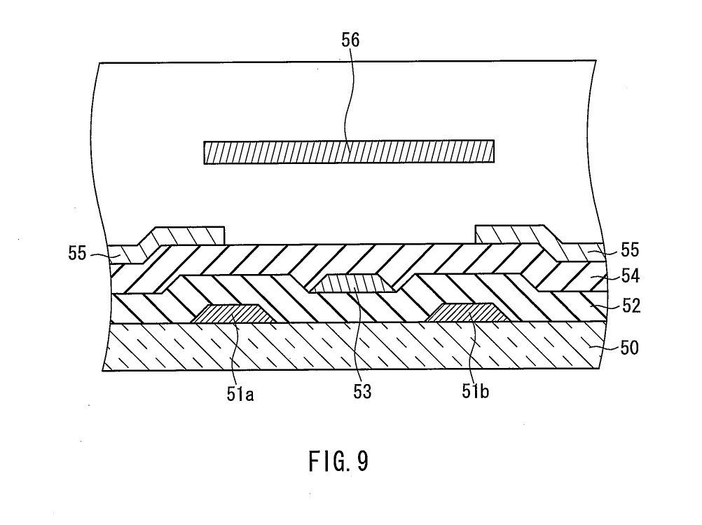

More specifically, as shown in FIG. 9, in a conventional active matrix substrate, two auxiliary capacitance wiring lines 51a, 51b are provided on a base material 50 in a mutually parallel configuration, and an insulating film 52 is used to cover these auxiliary capacitance wiring lines 51a, 51b. Additionally, in the conventional active matrix substrate, a data wiring line 53 is formed on the insulating film 52 between the two auxiliary capacitance wiring lines 51a, 51b, and an insulating film 54 is used to cover the data wiring line 53. Furthermore, in the conventional active matrix substrate, pixel electrodes 55 belonging to two adjacent pixels were provided on the insulating film 54. In addition, a black matrix 56 was placed such that it covered the edge portions of these two pixel electrodes 55.

In other words, in this conventional active matrix substrate, as shown in FIG. 9, the two auxiliary capacitance wiring lines 51a, 51b were provided on both sides of the data wiring line 53, as a result of which the dimension separating the two pixel electrodes 55 (i.e., the dimension separating the two adjacent pixels) had to be increased and the dimensions of the black matrix (dimension in the horizontal direction of the figure) had to be increased as well. As a result, the pixel aperture ratio in conventional active matrix substrates was difficult to improve.

Additionally, considering the accuracy of bonding between the active matrix substrate and the opposing substrate, the above-described black matrix was formed by increasing its dimensions in the above-described horizontal direction by a few microns in order to avoid the negative effects (i.e., light leakage) of misregistration. This made it even more difficult to improve the pixel aperture ratio in conventional active matrix substrates.

In view of the above-described problems, it is an object of the present invention to provide an active matrix substrate capable of achieving an improved aperture ratio while preventing light leakage from spaces between two adjacent pixels, as well as a display device utilizing the same.

### MEANS FOR SOLVING PROBLEM

In order to achieve the above-described object, the active matrix substrate according to the present invention, which is an active matrix substrate used as a substrate for display panels and including a plurality of data wiring lines and a plurality of scanning wiring lines arranged in a matrix-like configuration along with switching elements provided in the vicinity of the intersections between the data wiring lines and scanning wiring lines and pixels having pixel electrodes connected to the switching elements, includes a base material provided to permit mutual intersection between the data wiring lines and scanning wiring lines, and light shielding blocks that shield the edge portions of two adjacent pixel electrodes from light, are provided on the base material.

In an active matrix substrate configured as described above, the light shielding blocks that shield the edge portions of two adjacent pixel electrodes from light are provided on the above-described base material. Consequently, light leakage from spaces between two adjacent pixels can be prevented with the help of the light shielding blocks regardless of the presence of a black matrix. Therefore, in contradistinction to the conventional example described above, an improved aperture ratio can be achieved while preventing light leakage from spaces between two adjacent pixels.

Further, in the above-described active matrix substrate, the light shielding blocks are formed on the base material in the same layer and from the same material as the scanning wiring lines and, in addition, the light shielding blocks may be provided on the base material such that their edge portions are not connected to the scanning wiring lines.

In such a case, the light shielding blocks are easy to form.

Further, in the above-described active matrix substrate, the line width of the data wiring lines may be increased to cover unconnected isolation regions between the scanning wiring lines and the edge portions of the light shielding blocks.

In such a case, using the scanning wiring lines to cover the unconnected isolation regions between the scanning wiring lines and the edge portions of the light shielding blocks makes it possible to reliably prevent light leakage from spaces between two adjacent pixels.

Further, in the above-described active matrix substrate, there are provided auxiliary capacitance wiring lines used for generating auxiliary capacitance and the light shielding blocks are formed on the base material in the same layer and from the same material as the auxiliary capacitance wiring lines. In addition, the light shielding blocks may be provided on the base material such that their edge portions are not connected to the auxiliary capacitance wiring lines.

In such a case, the light shielding blocks are easy to form.

Further, in the above-described active matrix substrate, the line width of the data wiring lines may be increased to cover the unconnected isolation regions between the auxiliary capacitance wiring lines and the edge portions of the light shielding blocks.

In such a case, using the scanning wiring lines to cover the unconnected isolation regions between the auxiliary capacitance wiring lines and the edge portions of the light shielding blocks makes it possible to reliably prevent light leakage from spaces between two adjacent pixels.

Further, in the above-described active matrix substrate, there are provided auxiliary capacitance wiring lines used for generating auxiliary capacitance and the light shielding blocks preferably are formed on the base material in the same layer and from the same material as the scanning wiring lines and auxiliary capacitance wiring lines. In addition, the light shielding blocks preferably are provided on the base material such that their edge portions are not connected to the scanning wiring lines and auxiliary capacitance wiring lines.

In such a case, the light shielding blocks are easy to form.

Further, in the above-described active matrix substrate, the line width of the data wiring lines may be increased to cover the unconnected isolation regions between the scanning wiring lines and the edge portions of the light shielding blocks, and the unconnected isolation regions between the auxiliary capacitance wiring lines and the edge portions of the light shielding blocks.

In such a case, using the scanning wiring lines to cover the unconnected isolation regions between the scanning wiring lines and the edge portions of the light shielding blocks, and the unconnected isolation regions between the auxiliary capacitance wiring lines and the edge portions of the light shielding blocks makes it possible to reliably prevent light leakage from spaces between two adjacent pixels.

Further, in the above-described active matrix substrate, there are provided auxiliary capacitance wiring lines used for generating auxiliary capacitance and the light shielding blocks may be formed on the base material in the same layer and from the same material as the auxiliary capacitance wiring lines. In addition, the light shielding blocks may have their edge portions provided on the base material so as to be connected to the auxiliary capacitance wiring lines.

In such a case, the light shielding blocks can be used to generate auxiliary capacitance.

Additionally, in the above-described active matrix substrate, the light shielding blocks preferably are provided on the base material such that they face the edge portions of the two adjacent pixel electrodes.

In such a case, light leakage from spaces between two adjacent pixels can be reliably prevented.

Further, the display device of the present invention, which is a display device equipped with a display unit, is characterized in that an active matrix substrate according to any of the descriptions above is used in the display unit.

Using an active matrix substrate capable of achieving an improved aperture ratio while preventing light leakage from spaces between two adjacent pixels in the display unit of a display device configured as described above makes it possible to easily fashion a high-performance display device with a high-definition display unit.

### EFFECTS OF THE INVENTION

The present invention makes it possible to provide an active matrix substrate capable of achieving an improved aperture ratio while preventing light leakage from spaces between two adjacent pixels, as well as a display device utilizing the same.

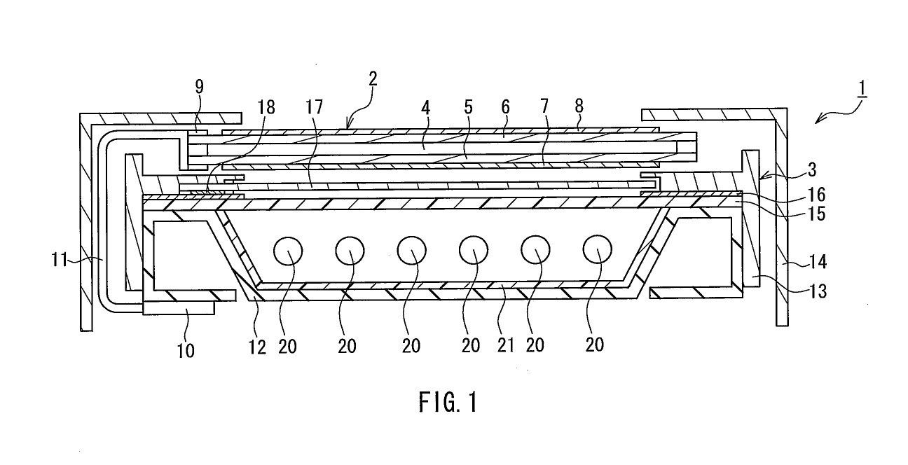

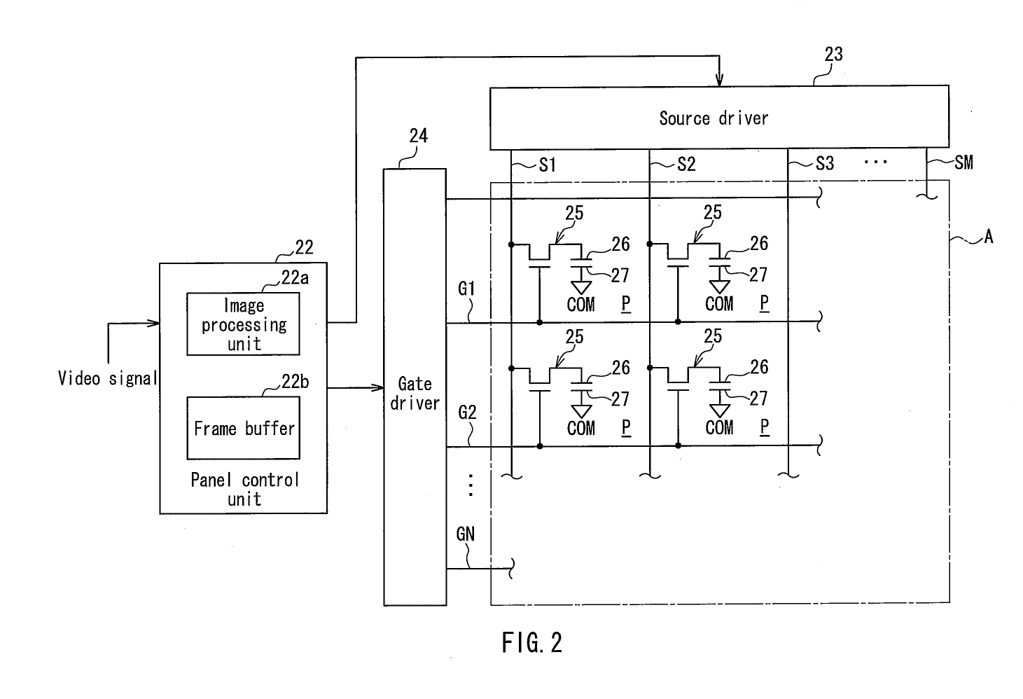

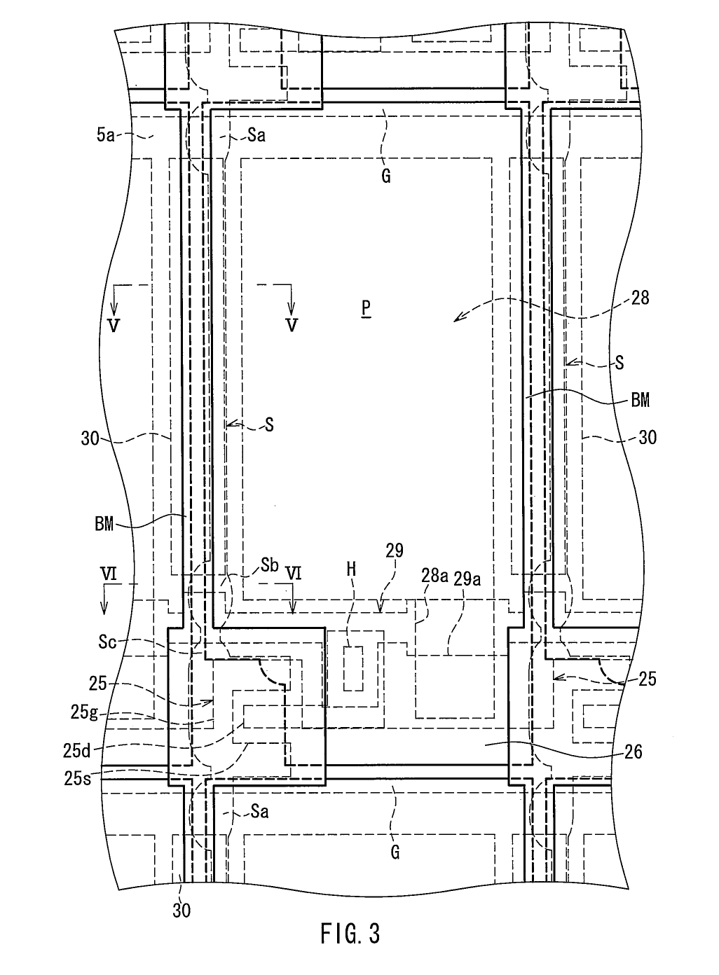

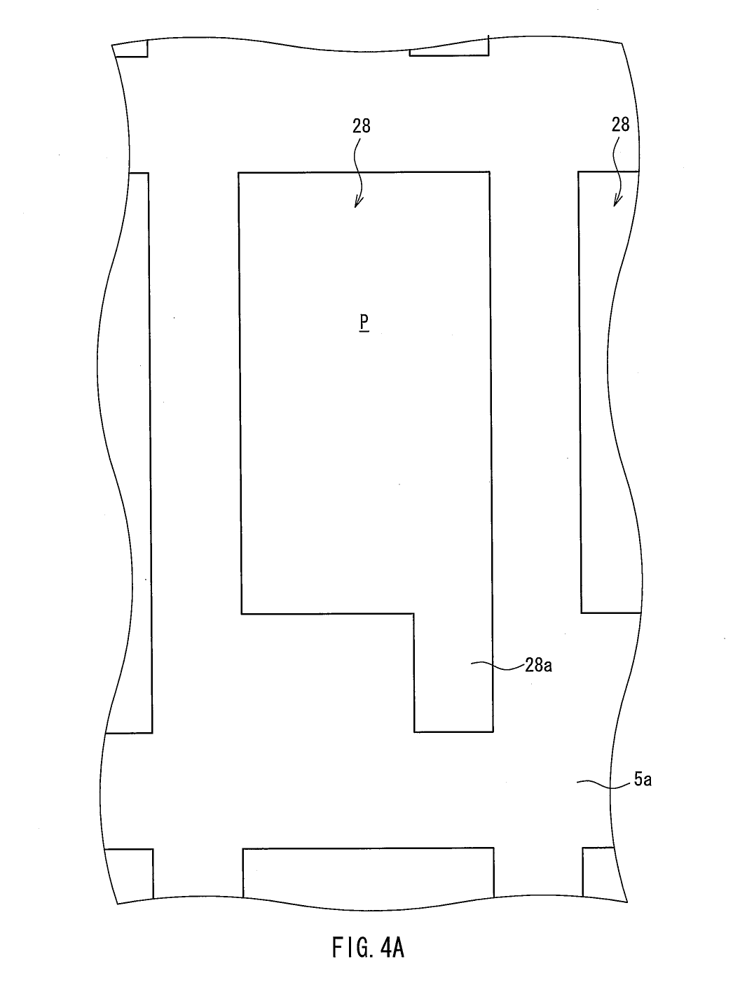

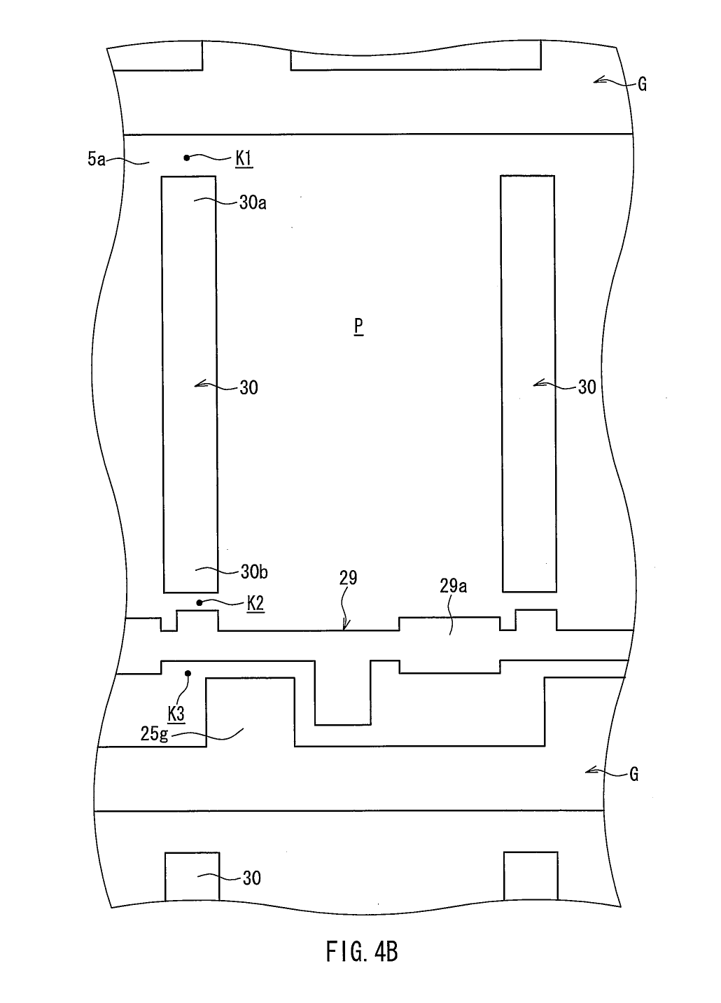

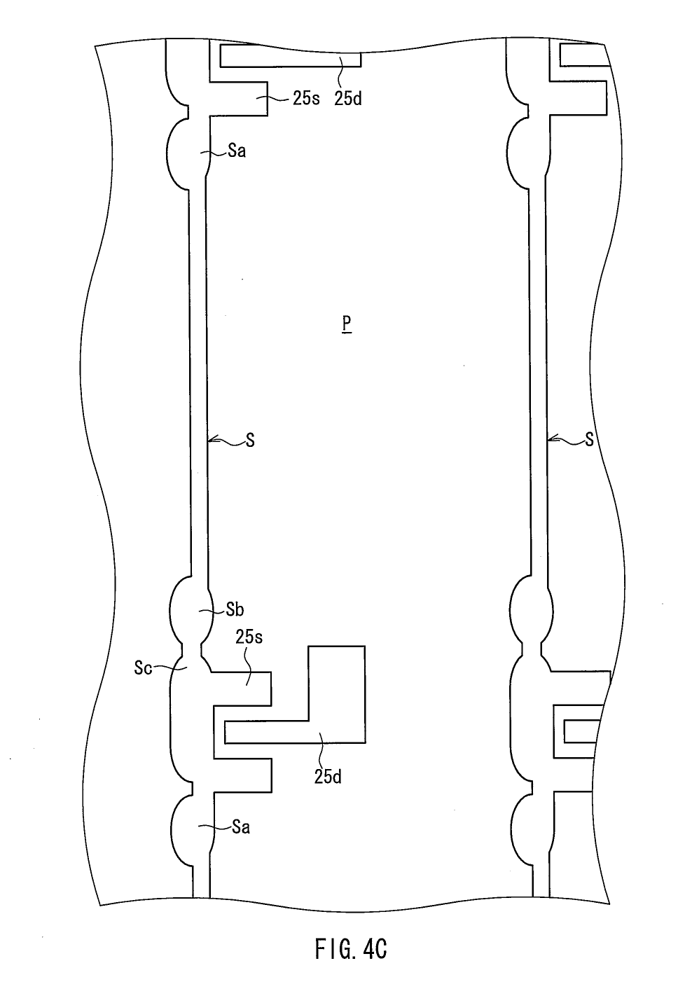

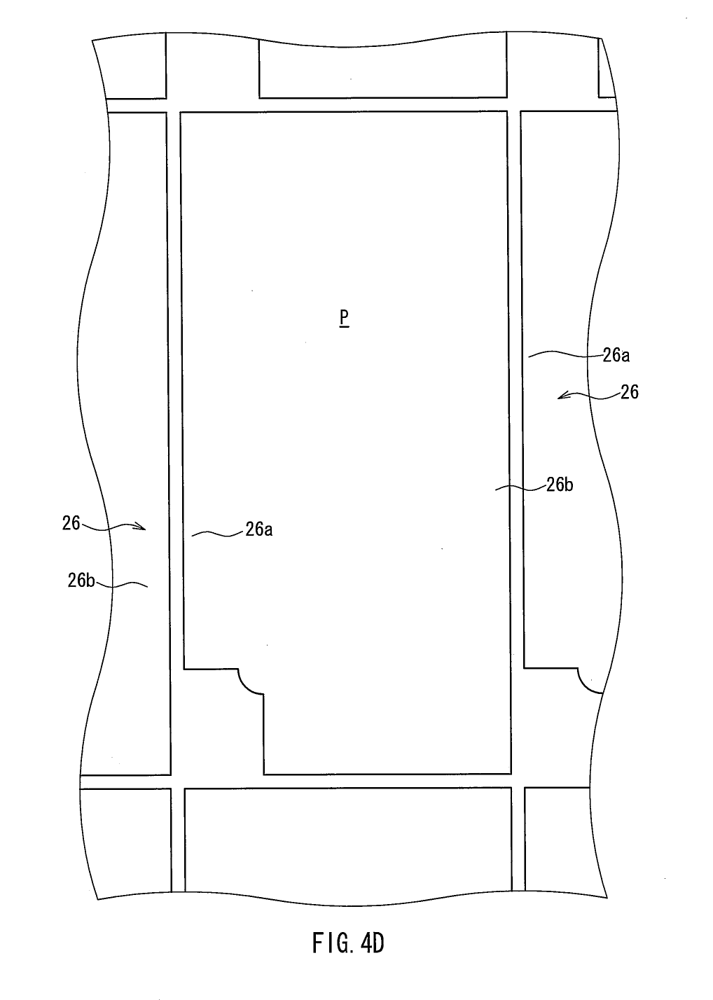

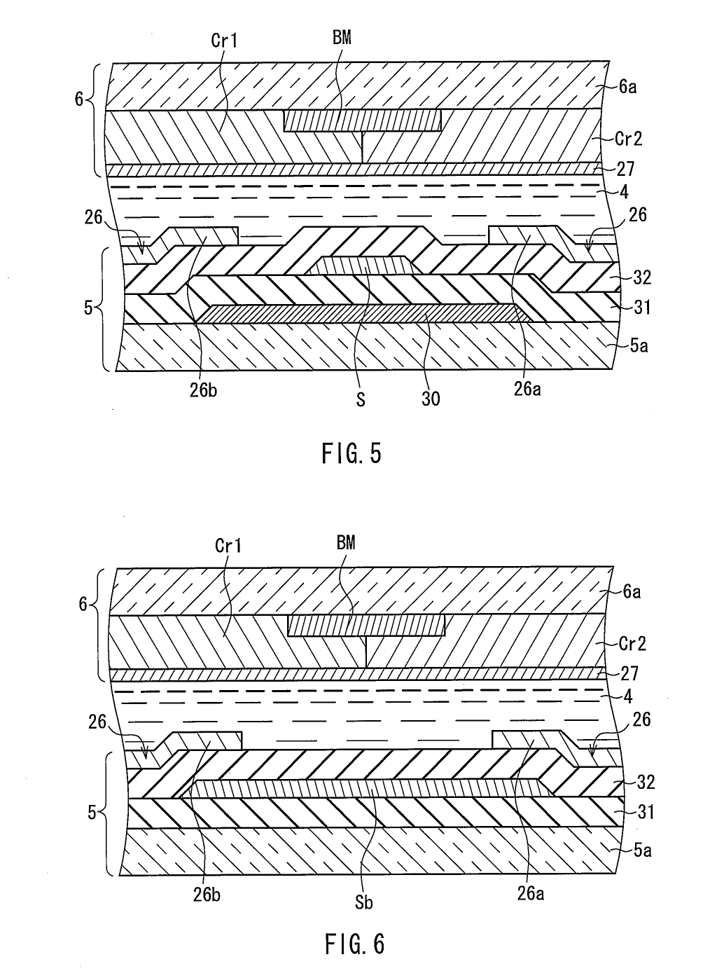

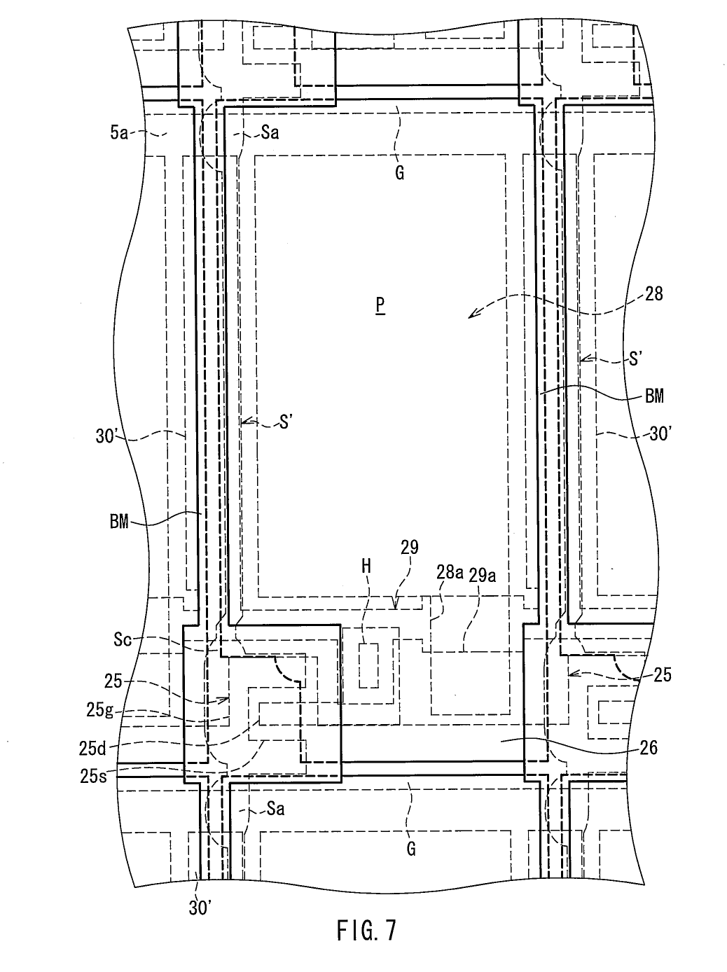

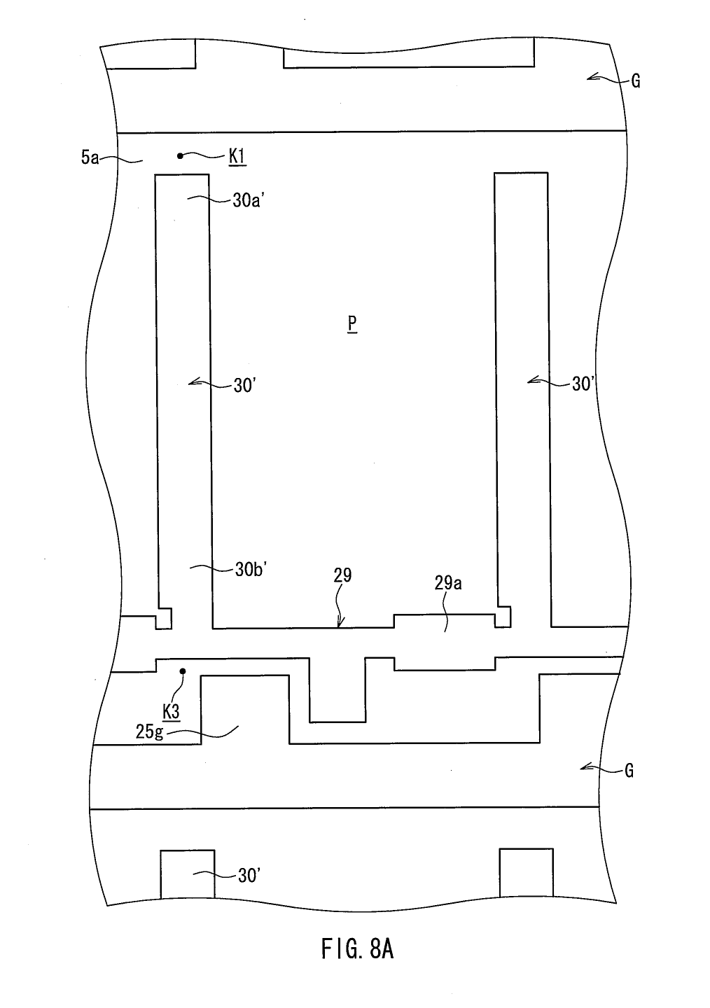

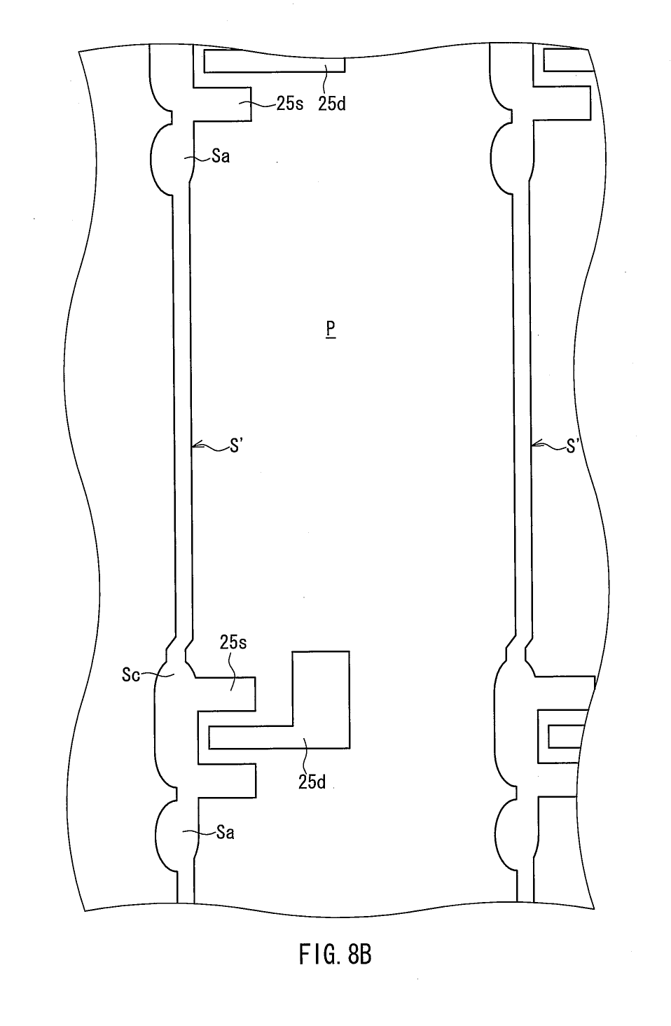

### BRIEF DESCRIPTION OF DRAWINGS

[FIG. 1] FIG. 1 is a schematic cross-sectional view of a liquid crystal display device according to a first embodiment of the present invention.

[FIG. 2] FIG. 2 is an explanatory diagram of main components of the active matrix substrate and the liquid crystal display device according to the above-described first embodiment.

[FIG. 3] FIG. 3 is an explanatory diagram of the specific pixel configuration shown in FIG. 2.

[FIG. 4A] FIG. 4A is a plan view showing the configuration of the auxiliary capacitance electrodes shown in FIG. 3.

[FIG. 4B] FIG. 4B is a plan view showing the configuration of the gate wiring lines, auxiliary capacitance wiring lines, and light shielding blocks shown in FIG. 3.

[FIG. 4C] FIG. 4C is a plan view showing the configuration of the source wiring lines shown in FIG. 3.

[FIG. 4D] FIG. 4D is a plan view showing the configuration of the pixel electrodes shown in FIG. 3.

[FIG. 5] FIG. 5 is a cross-sectional view taken along line V-V in FIG. 3.

[FIG. 6] FIG. 6 is a cross-sectional view taken along line VI-VI in FIG. 3.

[FIG. 7] FIG. 7 is an explanatory diagram of a specific pixel configuration in an active matrix substrate according to a second embodiment of the present invention.

[FIG. 8A] FIG. 8A is a plan view showing the configuration of the gate wiring lines, auxiliary capacitance wiring lines, and light shielding blocks shown in FIG. 7.

[FIG. 8B] FIG. 8B is a plan view showing the configuration of the source wiring lines shown in FIG. 7.

[FIG. 9] FIG. 9 is an explanatory diagram illustrating the problems of conventional active matrix substrates.

### DESCRIPTION OF THE INVENTION

Preferred embodiments of an active matrix substrate and a display device of the present invention will be explained below with reference to the drawings. It should be noted that, in the descriptions below, the invention is explained through examples, in which it is applied to transmissive-type liquid crystal display devices. Additionally, the dimensions of the components in the drawings do not provide a faithful representation of the actual dimensions of the components and the dimensional ratios, etc. between the components.

### Embodiment 1

FIG. 1 is a schematic cross-sectional view of a liquid crystal display device according to a first embodiment of the present invention. In the figure, a liquid crystal panel 2 used as a display unit, which is disposed such that the upper side of the drawing corresponds to its viewing side (display side), and an illumination device 3, which is disposed on the non-viewing side (lower side of the drawing) of the liquid crystal panel 2 and generates illumination light that illuminates the liquid crystal panel 2, are provided in the liquid crystal display device 1 of the present embodiment.

The liquid crystal panel 2 includes a liquid crystal layer 4, an active matrix substrate 5 of the present invention and a color filter substrate 6, which sandwich the liquid crystal layer 4 therebetween, and polarizing plates 7, 8, which are provided on the respective exterior surfaces of the active matrix substrate 5 and color filter substrate 6. Further, the liquid crystal panel 2 is provided with a driver device 9, which is used to drive the liquid crystal panel 2, and a drive circuit device 10, which is connected to the driver device 9 through a flexible printed circuit board 11, with the liquid crystal panel 2 adapted to permit driving the liquid crystal layer 4 on a pixel-by-pixel basis. In addition, the desired images are displayed on the liquid crystal panel 2 by the liquid crystal layer 4 as a result of modulating the polarization state of the above-described illumination light incident through the polarizing plate 7 and controlling the amount of light passing through the polarizing plate 8.

A chassis 12, which has a bottom and an open top in the drawing (on the side facing the liquid crystal panel 2), and an enclosure-shaped frame 13, which is placed on the side of the chassis 12 facing the liquid crystal panel 2, are provided in the illumination device 3. Further, the chassis 12 and the frame 13, which are constructed from metal or synthetic resin, are held together by a bezel 14 with an L-shaped cross section when the liquid crystal panel 2 is placed above the frame 13. As a result, the illumination device 3 is attached to the liquid crystal panel 2 and integrated into a transmissive-type liquid crystal display device 1, in which illumination light from the illumination device 3 is incident on the liquid crystal panel 2.

Additionally, the illumination device 3 includes a diffuser 15, which is placed so as to cover the opening in the chassis 12, an optical sheet 17, which is placed above the diffuser 15 on the side facing the liquid crystal panel 2, and a reflector sheet 21, which is provided on the inner surface of the chassis 12. Further, plural, e.g. six cold cathode fluorescent lamps 20 are provided in the illumination device 3 inside the chassis 12, under the liquid crystal panel 2, thereby forming a direct-lit illumination device 3. In addition, light generated in the illumination device 3 by the cold cathode fluorescent lamps 20 is emitted as the above-described illumination light from the light-emitting face of the illumination device 3, which is disposed facing the liquid crystal panel 2.

It should be noted that while the description above focused on a configuration utilizing a direct-lit illumination device 3, the present embodiment is not limited thereto and may be applied to edge-lit illumination devices equipped with light guiding plates. Additionally, illumination devices equipped with other light sources, such as LEDs or lamps other than cold cathode fluorescent lamps, i.e. hot cathode fluorescent lamps, etc., can also be used.

The diffuser 15, which is constructed, for example, from a rectangular piece of synthetic resin or vitreous material with a thickness of about 2 mm, diffuses light generated by the cold cathode fluorescent lamps 20 and emits it towards the optical sheet 17. Additionally, the diffuser 15, which rests on a frame-like surface whose four sides are provided on the upper face of the chassis 12, is incorporated into the illumination device 3 such that it is sandwiched between the surface of the chassis 12 and the inner surface of the frame 13, with resiliently deformable pressure members 16 interposed therebetween. Furthermore, the diffuser 15 has its generally central portion supported by a transparent support member (not shown) installed inside the chassis 12, thereby preventing it from bending into the chassis 12.

Additionally, the diffuser 15 is held in a moveable manner between the chassis 12 and the pressure member 16 such that even when (plastic) deformation due to expansion and contraction occurs in the diffuser 15 as a result of thermal effects such as heat buildup in the cold cathode fluorescent lamps 20 or a temperature increase inside the chassis 12, etc., the pressure member 16 undergoes elastic deformation, thereby causing the plastic deformation to be absorbed and providing maximum protection against a reduction in the diffusivity of the light generated by the cold cathode fluorescent lamps 20. Additionally, from the standpoint of preventing the occurrence of warping, yellowing, heat deformation, etc. due to the above-described thermal effects, it is preferable to use a diffuser 15 made of a vitreous material that is more resistant to heat than synthetic resin.

A light collecting sheet that is formed, for example, of a synthetic resin film with a thickness of 0.5 mm, is included in the optical sheet 17 and is adapted to enhance the brightness of the above-described illumination light incident on the liquid crystal panel 2. Further, if necessary, prism sheets, diffuser sheets, polarization sheets, and other publicly-known optical sheet materials used to improve the visual quality of the display surface of the liquid crystal panel 2 are laminated on the optical sheet 17. In addition, the optical sheet 17 is adapted to convert light emitted from the diffuser 15 into planar light with a uniform brightness at or higher than a predetermined brightness level (for example, 5000 cd/m²) and make it incident on the liquid crystal panel 2 as illumination light. In addition to the description above, it should be noted that, for example, diffuser sheets or other optical members used to adjust the angle of view of the liquid crystal panel 2 may be suitably laminated on top of the liquid crystal panel 2 (on the display side).

Further, a protruding portion that protrudes to the left in FIG. 1 is formed in the optical sheet 17 in the central portion on the left-hand side of the same drawing, which is the upper side when, for example, the liquid crystal display device 1 is in actual use. In addition, in the optical sheet 17, only the above-described protrusion is sandwiched between the inner surface of the frame 13 and the pressure member 16, with elastic material 18 interposed therebetween, as a result of which the optical sheet 17 is incorporated into the illumination device 3 in a stretchable state. Consequently, even if (plastic) deformation due to expansion and contraction occurs in the optical sheet 17 as a result of the above-described thermal effects such as heat buildup in the cold cathode fluorescent lamps 20, etc., it is adapted to permit free deformation through expansion and contraction relative to the above-described protruding portion, thereby providing maximum protection against the occurrence of wrinkling, bending, and the like in the optical sheet 17. As a result, the liquid crystal display device 1 is afforded maximum protection against brightness non-uniformity and other types of visual quality degradation on the display surface of the liquid crystal panel 2 due to the bending, etc. of the optical sheet 17.

The lamps used as the cold cathode fluorescent lamps 20 are straight tube-shaped lamps, and their electrode portions (not shown), which are provided at the opposite ends thereof, are supported on the outside of the chassis 12. Further, narrow tubes of superior emission efficiency with a diameter of 3.0-4.0 mm are used as the cold cathode fluorescent lamps 20, with the cold cathode fluorescent lamps 20 held inside the chassis 12 using a light source holder, not shown, such that the distance from each of them to the diffuser 15 and to the reflector sheet 21 is maintained at a predetermined distance. Furthermore, the cold cathode fluorescent lamps 20 are disposed such that their longitudinal direction is parallel to the direction normal to the acting direction of gravity. Consequently, the mercury (vapor) sealed inside the cold cathode fluorescent lamps 20 is prevented from collecting at one of the ends in the longitudinal direction under the action of gravity, thereby greatly improving lamp life.

The reflector sheet 21, which is formed, for example, of a metal thin film of aluminum, silver, or another metal of high light reflectivity with a thickness of 0.2-0.5 mm, acts as a reflector reflecting the light of the cold cathode fluorescent lamps 20 towards the diffuser 15. Consequently, the light emitted from the cold cathode fluorescent lamps 20 can be effectively reflected towards the diffuser 15 and the efficiency of utilization of the light and its brightness on the diffuser 15 can be raised. In addition to this description, it should be noted that synthetic resin-based reflective sheeting materials can be used instead of the metal thin films described above. For example, white paint etc. of high light reflectivity can be applied to the inner surface of the chassis 12 in order to use the inner surface as a reflector.

Next, the active matrix substrate 5 of the present embodiment will be specifically described with reference to FIG. 2.

FIG. 2 is an explanatory diagram of main components of the active matrix substrate and the liquid crystal display device according to the above-described first embodiment.

In FIG. 2, a panel control unit 22, which controls the actuation of the liquid crystal panel 2 (FIG. 1) serving as the above-described display unit used for displaying information such as text, images, etc., and a gate driver 24 and source driver 23, which operate based on instruction signals received from this panel control unit 22, are provided in the liquid crystal display device 1 (FIG. 1).

The panel control unit 22, which is provided in the drive circuit device 10 (FIG. 1), receives video signals from outside the liquid crystal display device 1. Additionally, the panel control unit 22 includes an image processing unit 22a, which generates instruction signals for the source driver 23 and gate driver 24 by performing predetermined image processing on the received video signals, and a frame buffer 22b, which can store display data for a single frame contained in the received video signal. In addition, the panel control unit 22 controls the actuation of the source driver 23 and gate driver 24 in response to received video signals, thereby displaying information corresponding to the video signal on the liquid crystal panel 2.

The source driver 23 and the gate driver 24 provided in the drive device 9 (FIG. 1) are placed on the active matrix substrate 5 of the present embodiment, which is an array substrate. More specifically, the source driver 23 is placed on the surface of the active matrix substrate 5 in the horizontal direction of the liquid crystal panel 2 in a region located outside of the effective display space A of the liquid crystal panel 2 used as a display panel. Additionally, the gate driver 24 is placed on the surface of the active matrix substrate 5 in the vertical direction of the liquid crystal panel 2 in a region located outside of the above-described effective display space A.

Additionally, the source driver 23 and the gate driver 24 are drive circuits that drive a plurality of pixels P provided on the liquid crystal panel 2 on a pixel-by-pixel basis, with a plurality of source wiring lines S1-SM (where M is an integer of 2 or more, hereinafter collectively referred to as “S”) and a plurality of gate wiring lines G1-GN (where N is an integer of 2 or more, hereinafter collectively referred to as “N”) being connected to the source driver 23 and the gate driver 24, respectively. These source wiring lines S and gate wiring lines G, which constitute data wiring lines and scanning wiring lines, respectively, are arranged in a matrix-like configuration so as to permit mutual intersection on a base material, which will be described later.

Additionally, thin film transistors (Thin Film Transistors) 25, which are used as switching elements, and the above-described pixels P, which have pixel electrodes 26 connected to the thin film transistors 25, are provided in the vicinity of the intersections between these source wiring lines S and gate wiring lines G. Namely, regions that constitute a plurality of pixels P are formed on the active matrix substrate 5 in regions produced by the source wiring lines S and gate wiring lines G as a result of partitioning in a matrix-like manner. These plural pixels P include red, green, and blue-colored pixels. Additionally, these red, green, and blue-colored pixels are disposed successively, for instance, in this order, in parallel to the gate wiring lines G1-GN.

Further, along with being provided in each pixel P, the gate electrodes of the thin film transistors 25 are connected to the gate wiring lines G1-GN. On the other hand, the source electrodes of the thin film transistors 25 are connected to the source wiring lines S1-SM. Additionally, the above-described pixel electrodes 26, which are provided in each pixel P, are connected to the drain electrodes of the thin film transistors 25. Further, in each pixel P, a common electrode 27 is formed facing the pixel electrodes 26 such that the liquid crystal layer 4 provided in the liquid crystal panel 2 is sandwiched therebetween.

Here, the structure of the pixels P in the active matrix substrate 5 of the present embodiment will be specifically described with reference to FIG. 3-FIG. 6.

FIG. 3 is an explanatory diagram of the specific pixel configuration shown in FIG. 2. FIG. 4A is a plan view showing the configuration of the auxiliary capacitance electrodes shown in FIG. 3 and FIG. 4B is a plan view showing the configuration of the gate wiring lines, auxiliary capacitance wiring lines, and light shielding blocks shown in FIG. 3. FIG. 4C is a plan view showing the configuration of the source wiring lines shown in FIG. 3 and FIG. 4D is a plan view showing the configuration of the pixel electrodes shown in FIG. 3. FIG. 5 is a cross-sectional view taken along line V-V in FIG. 3 and FIG. 6 is a cross-sectional view taken along line VI-VI in FIG. 3.

As shown in FIG. 3, the source wiring lines S and gate wiring lines G are provided on the active matrix substrate 5 in parallel to the vertical and horizontal direction of the same FIG. 3, respectively, with the regions of the pixels P defined by two adjacent source wiring lines S and two adjacent gate wiring lines G. Additionally, a black matrix BM, which is provided on the color filter substrate 6 (FIG. 1), is disposed above the source wiring lines S and thin film transistors 25.

Further, in the active matrix substrate 5, the source wiring lines S, the gate wiring lines G, the thin film transistors 25, the pixel electrodes 26, the auxiliary capacitance electrodes 28, the auxiliary capacitance wiring lines 29, and the light shielding blocks 30 are formed on the base material 5a, which is formed, for example, of a transparent vitreous material or synthetic resin material.

In particular, as shown in FIG. 4A and FIG. 4B, in the active matrix substrate 5, the auxiliary capacitance electrodes 28, the gate wiring lines G, the auxiliary capacitance wiring lines 29, and the light shielding blocks 30 are provided directly on the base material 5a. The gate electrodes 25g of the thin film transistors 25 are provided integrally with the gate wiring lines G. Additionally, connector portions 28a and connector portions 29a, which are used for providing mutual electrical connections, are formed, respectively, in the auxiliary capacitance electrodes 28 and in the auxiliary capacitance wiring lines 29. Namely, in the auxiliary capacitance electrodes 28 and the auxiliary capacitance wiring lines 29, the connector portions 28a and the connector portions 29a are provided on the base material 5a such that they are disposed above and below each other and in a mutually abutting relationship, with the auxiliary capacitance electrodes 28 and the auxiliary capacitance wiring lines 29 being electrically connected together through these connector portions 28a and connector portions 29a.

Further, the auxiliary capacitance electrodes 28 are constituted by transparent film electrodes such as ITO films, etc., and when a voltage is applied to the auxiliary capacitance wiring lines 29 by a power source, not shown, the auxiliary capacitance electrodes 28 generate a predetermined auxiliary capacitance with respect to the pixel electrodes 26.

Additionally, the gate wiring lines G, the auxiliary capacitance wiring lines 29, and the light shielding blocks 30 are formed simultaneously from the same material using, for example, photolithographic techniques. Namely, these gate wiring lines G, auxiliary capacitance wiring lines 29, and light shielding blocks 30, which are formed, for example, of an aluminum-based material or a film obtained by laminating a film of a high permittivity material on an underlying or overlying layer of an aluminum-based material, are formed in a batch mode on the base material 5a by etching with the help of masks patterned in a predetermined manner.

Further, as shown in FIG. 4B, the light shielding blocks 30 are provided on the base material 5a such that the edge portions 30a and 30b are not connected, respectively, to the gate wiring lines G and the auxiliary capacitance wiring lines 29. Namely, the light shielding blocks 30 are placed on the base material 5a such that an unconnected isolation region K1 is formed between the edge 30a and the gate wiring line G, and, in addition, an unconnected isolation region K2 is formed between the edge 30b and the auxiliary capacitance wiring line 29. Additionally, the gate wiring line G and the auxiliary capacitance wiring line 29 are placed on the base material 5a such that an unconnected isolation region K3 is formed between the gate electrode 25g of the gate wiring line G and the auxiliary capacitance wiring line 29.

Further, as described above, the light shielding blocks 30 are not connected to the gate wiring lines G and the auxiliary capacitance wiring lines 29, as a result of which the light shielding blocks 30 are provided in an electrically floating condition within the active matrix substrate 5 and are adapted to prevent unintended generation of parasitic capacitance with respect to the pixel electrodes 26.

Furthermore, the light shielding blocks 30, which are placed on the base material 5a facing the edge portions 26a, 26b of the two adjacent pixel electrodes 26, are provided such that they shield the edge portions 26a, 26b of the two adjacent pixel electrodes 26 from light. In addition, the light shielding blocks 30 prevent light leakage from spaces between two adjacent pixels P in conjunction with hereinafter described widened portions provided in the source wiring lines S (as discussed in more detail below).

Further, as shown in FIG. 4C, the source wiring lines S and the drain electrodes 25d of the thin film transistors 25 are formed in a predetermined pattern.

These source wiring lines S and the drain electrodes 25d are formed, for example, of an aluminum-based material or a film obtained by laminating a film of a high permittivity material on an underlying or overlying layer of an aluminum-based material. Additionally, over the base material 5a, these source wiring lines S and drain electrodes 25d are formed above the gate wiring lines G, the auxiliary capacitance electrodes 28, the auxiliary capacitance wiring lines 29, and the light shielding blocks 30, with a hereinafter described insulating film interposed therebetween. Further, the source electrodes 25s of the thin film transistors 25 are provided integrally with the source wiring lines S. Additionally, the drain electrodes 25d are electrically connected to the pixel electrodes 26 through contact holes H (FIG. 3).

Further, widened portions Sa, Sb, and Sc of increased line width are provided in the source wiring lines S. These widened portions Sa-Sc are adapted to cover the above-described isolation regions K1-K3, respectively, thereby shielding the corresponding isolation regions K1-K3 from light. Namely, the widened portion Sa, which is adapted to cover the isolation region K1 between the gate wiring line G and the edge 30a of the light shielding block 30, shields the isolation region K1 from light. Further, the widened portion Sb, which is adapted to cover the isolation region K2 between the auxiliary capacitance wiring line 29 and the edge 30b of the light shielding block 30, shields the isolation region K2 from light. Additionally, the widened portion Sc, which is adapted to cover the isolation region K3 between the gate wiring line G and the auxiliary capacitance wiring line 29, shields the isolation region K3 from light.

Further, as shown in FIG. 4D, the pixel electrode 26 is configured in a predetermined shape. This pixel electrode 26 is formed above the source line S and the drain electrode 25d over the base material 5a, with a hereinafter described insulating film interposed therebetween. Additionally, this pixel electrode 26 is constituted by a transparent film electrode, such as an ITO film, etc. Furthermore, in two adjacent pixel electrodes 26, the light shielding blocks 30 are provided in an opposed configuration beneath the edge portion 26a and the edge portion 26b.

Further, in the liquid crystal display device 1 of the present embodiment, as shown in FIG. 5, in the active matrix substrate 5, the light shielding blocks 30 are provided on the base material 5a, and, furthermore, a transparent insulating film 31 is formed so as to cover the light shielding blocks 30. Additionally, in the active matrix substrate 5, the source wiring line S is provided on the insulating film 31 at a location directly above the central portion of the light shielding block 30 and an insulating film 32 is formed so as to cover this source wiring line S. Further, in the active matrix substrate 5, the pixel electrodes 26 are provided on the transparent insulating film 32.

Furthermore, in the active matrix substrate 5, the left edge portion of the light shielding block 30 is provided facing the edge portion 26b of the pixel electrode 26 on the left, and the right edge portion of the light shielding block 30 is provided facing the edge portion 26a of the pixel electrode 26 on the right. Consequently, the light shielding block 30 can shield the edge portions 26a, 26b of the two adjacent pixel electrodes 26 from light and light leakage from spaces between two adjacent pixels P can be reliably prevented.

It should be noted that in the active matrix substrate 5, as shown in FIG. 5, the source wiring lines S and pixel electrodes 26 are provided at mutually spaced locations in the vertical direction of the figure, which ensures a significant reduction in the parasitic capacitance generated between these source wiring lines S and pixel electrodes 26.

Additionally, in the liquid crystal display device 1 of the present embodiment, the color filter substrate 6 includes a base material 6a, a black matrix BM and color filter layers Cr1, Cr2 formed on this base material 6a, and a common electrode 27 provided so as to cover the color filter layers Cr1, Cr2. In the same manner as the base material 5a, this base material 6a is formed, for example, of a transparent vitreous material or synthetic resin material. Additionally, the color filter layers Cr1, Cr2 are constituted by color filters of two mutually different colors selected from among red (R), green (G), and blue (B).

Further, in the liquid crystal display device 1 of the present embodiment, in the portions where no light shielding blocks 30 are provided, the widened portions Sa-Sc provided in the source wiring lines S are adapted to prevent light leakage from spaces between two adjacent pixels P. In particular, as illustrated in FIG. 6, in the above-described isolation region K2, the insulating film 31 is provided on the base material 5a and the widened portion Sb is formed on this insulating film 31. Additionally, the insulating film 32 is provided so as to cover the widened portion Sb, and, furthermore, pixel electrodes 26 are provided on this insulating film 32. Here, the widened portion Sb has its left edge portion provided facing the edge portion 26b of the pixel electrode 26 on the left, and its right edge portion provided facing the edge portion 26a of the pixel electrode 26 on the right. Consequently, the widened portion Sb can shield the edge portions 26a, 26b of two adjacent pixel electrodes 26 from light and light leakage from spaces between two adjacent pixels P can be reliably prevented.

In the active matrix substrate 5 of the present embodiment configured as described above, the light shielding blocks 30 that shield the edge portions 26a, 26b of the two adjacent pixel electrodes from light are provided on the base material 5a. Additionally, in the active matrix substrate 5 of the present embodiment, the widened portions Sa-Sc are provided in the source wiring lines S so as to cover the above-described isolation regions K1-K3, respectively, and these widened portions Sa-Sc shield the respective isolation regions K1˜K3 from light. Consequently, as shown in FIG. 5 and FIG. 6, light leakage from spaces between two adjacent pixels P in the active matrix substrate 5 of the present embodiment can be prevented regardless of the presence of a black matrix. Therefore, in the active matrix substrate 5 of the present embodiment, in contradistinction to the conventional example described above, an improved aperture ratio can be achieved while preventing light leakage from spaces between two adjacent pixels P.

Further, in the active matrix substrate 5 of the present embodiment, the light shielding block 30 is provided on the base material 5a facing the edge portions 26a, 26b of two adjacent pixel electrodes 26. Consequently, in the active matrix substrate 5 of the present embodiment, light leakage from spaces between two adjacent pixels P can be reliably prevented. As a result, it is possible to ensure a reduction in the width of the black matrix BM in the liquid crystal display 1 device of the present embodiment.

Further, in the present embodiment, the use of an active matrix substrate 5 capable of achieving an improved aperture ratio while preventing light leakage from spaces between two adjacent pixels P in the liquid crystal panel (display unit) 2 makes it possible to easily fashion a high-performance liquid crystal display device 1 with a high-definition liquid crystal panel 2.

It should be noted that while the description above discussed a configuration, in which the black matrix BM was provided on the color filter substrate 6, in the liquid crystal display device 1 of the present embodiment, light leakage from spaces between two adjacent pixels P can be prevented with the help of the light shielding blocks 30 and the widened portions Sa-Sc of the source wiring lines S. For this reason, the installation of the black matrix BM in the liquid crystal display 1 device of the present embodiment can be omitted (in the same manner as in the hereinafter described Embodiment 2).

### Embodiment 2

FIG. 7 is an explanatory diagram of a specific pixel configuration in an active matrix substrate according to a second embodiment of the present invention. FIG. 8A is a plan view showing the configuration of the gate wiring lines, auxiliary capacitance wiring lines, and light shielding blocks shown in FIG. 7. FIG. 8B is a plan view showing the configuration of the source wiring lines shown in FIG. 7. In the figure, the main difference between the present embodiment and the first embodiment described above is that the edge portions of the light shielding blocks are provided on the base material such that they are connected to the auxiliary capacitance wiring lines. It should be noted that the same reference numerals are assigned to elements in common with the above-described first embodiment and duplicate descriptions are omitted.

Namely, as illustrated in FIG. 7 and FIG. 8, in the active matrix substrate 5 of the present embodiment, the light shielding blocks 30′ are provided on the base material 5a such that they are connected to the auxiliary capacitance wiring lines 29. More specifically, as shown in FIG. 8A, the edge portions 30a′ of the light shielding blocks 30′ are provided on the base material 5a such that they are not connected to the gate wiring lines G while the edge portions 30b′ are provided on the base material 5a such that they are connected to the auxiliary capacitance wiring lines 29. Namely, in the active matrix substrate 5 of the present embodiment, in the same manner as in the first embodiment, an isolation region K1 is formed between the edge 30a′ and the gate line G. On the other hand, in contradistinction to the first embodiment, in the active matrix substrate 5 of the present embodiment, no isolation region K2 is formed on the edge 30b′ side.

Further, as shown in FIG. 8B, in contradistinction to Embodiment 1, in the active matrix substrate 5 of the present embodiment, no widened portions Sb are formed in the source wiring lines S′. In other words, in the active matrix substrate 5 of the present embodiment, light leakage from spaces between two adjacent pixels P in the connected portions between the edges 30b′ and the auxiliary capacitance wiring lines 29 can be prevented, and, therefore, no widened portions Sb are provided in the source lines S′.

The configuration above permits the same operation and effects as in the above-described first embodiment to be achieved in the present embodiment. Further, due to the fact that in the active matrix substrate 5 of the present embodiment the edge portions 30b′ of the light shielding blocks 30′ are connected to the auxiliary capacitance wiring lines 29, the light shielding blocks 30′ can be made to function as auxiliary capacitance electrodes and can be used in the generation of auxiliary capacitance. Additionally, since the light shielding blocks 30′ can be made to function as auxiliary capacitance electrodes in this manner, the installation of auxiliary capacitance electrodes 28 in the active matrix substrate 5 of the present embodiment can be omitted.

It should be noted that all of the embodiments described above are merely illustrative, and not restrictive. The technical scope of the present invention is defined by the claims and all modifications that come within the range of equivalency of the configurations described herein are included in the technical scope of the present invention.

For example, although in the descriptions above the present invention was discussed by way of examples, in which it was applied to transmissive-type liquid crystal display devices, there are no limitations whatsoever on the display device of the present invention as long as it uses a display panel equipped with an active matrix substrate in its display unit. In other words, the display device of the present invention is only required to use an active matrix substrate that has a plurality of data wiring lines and a plurality of scanning wiring lines arranged in a matrix-like configuration, switching elements provided in the vicinity of the intersections between the data wiring lines and scanning wiring lines, and pixels having pixel electrodes connected to the switching elements.

In particular, the display device of the present invention can be applied to various display devices utilizing transflective-type and reflective-type liquid crystal panels, or organic EL (Electronic Luminescence) elements, inorganic EL elements, field emission displays (Field Emission Displays), and other active matrix substrates.

Further, in the descriptions above, the present invention was discussed by way of examples, in which the light shielding blocks, the gate wiring lines (scanning wiring lines), and the auxiliary capacitance wiring lines were formed from the same material and in the same layer on the base material, and, in addition, the source wiring lines (data wiring lines) were provided above these light shielding blocks, scanning wiring lines, and auxiliary capacitance wiring lines. However, there are no limitations whatsoever on the active matrix substrate of the present invention as long as the substrate includes a base material provided so as to permit mutual intersection between the data wiring lines and the scanning wiring lines, and as long as the light shielding blocks that shield the edge portions of two adjacent pixel electrodes from light are provided on the base material.

More specifically, a configuration may be used in which, for example, the scanning wiring lines are provided above the data wiring lines, the auxiliary capacitance wiring lines are provided in a layer different from that of the light shielding blocks and the scanning wiring lines, and, in addition, the auxiliary capacitance wiring lines are wired to pass through a generally central portion between two adjacent scanning wiring lines. Further, a configuration may be used, in which the light shielding blocks are constructed from a synthetic resin and another organic compound, and, in addition, a single rectilinearly configured light shielding block is provided in a layer different from that of the scanning wiring lines and the auxiliary capacitance wiring lines.

Furthermore, in contradistinction to the embodiments described above, the use of a rectilinear light shielding block such as the one described above makes it possible to prevent light leakage from spaces between two adjacent pixels P with the help of the light shielding blocks alone, without forming the above-described widened portions in the source wiring lines.

However, forming the light shielding blocks on the base material in the same layer and from the same material as the scanning wiring lines and the auxiliary capacitance wiring lines, as illustrated in the embodiments described above, is preferable from the standpoint of being able to easily form the light shielding blocks and being able to simplify the process of the active matrix substrate fabrication. Specifically, forming the light shielding blocks and the scanning wiring lines and/or the auxiliary capacitance wiring lines in mutually different layers requires advance preparation of plural masks. As a result, the number of masks required for the active matrix substrate fabrication process is increased, which makes it impossible to simplify the fabrication process.

Further, the descriptions above discussed an example, in which the line width of the source wiring lines (data wiring lines) was increased to cover unconnected isolation regions between the gate wiring lines (scanning wiring lines) and the edge portions of the light shielding blocks, as well as unconnected isolation regions between the auxiliary capacitance wiring lines and the edge portions of the light shielding blocks. However, the inventive display device is not limited in this respect, and, for example, permits the use of configurations, in which the width of the black matrix is partially increased to cover the above-described isolation regions.

### INDUSTRIAL APPLICABILITY

The present invention is useful in the fabrication of active matrix substrates capable of achieving an improved aperture ratio while preventing light leakage from spaces between two adjacent pixels, as well as display devices utilizing the same.

### REFERENCE SIGNS LIST

1 Liquid crystal display device (display device).

2 Liquid crystal panel (display unit).

5 Active matrix substrate.

5a Base material.

25 Thin film transistor (switching element).

26 Pixel electrode.

26a, 26b. Edges.

29 Auxiliary capacitance wiring line.

30, 30′ Light shielding blocks.

30a, 30b, 30a′, 30b′ Edges.

S1-SM, S, S′ Source wiring lines (data wiring lines).

G1-GN, G. Gate wiring lines (scanning wiring lines).

P Pixel.

K1, K2, K3 Isolation regions.

1. An active matrix substrate serving as a substrate for a display panel and comprising a plurality of data wiring lines and a plurality of scanning wiring lines arranged in a matrix-like configuration along with switching elements provided in the vicinity of the intersections between the data wiring lines and the scanning wiring lines and pixels having pixel electrodes connected to the switching elements,
wherein the active matrix substrate comprises a base material provided so as to permit mutual intersection of the data wiring lines and the scanning wiring lines, and
light shielding blocks shielding edge portions of two adjacent pixel electrodes from light are provided on the base material.

2. The active matrix substrate according to claim 1,
wherein the light shielding blocks are formed on the base material in the same layer and from the same material as the scanning wiring lines, and
the light shielding blocks are provided on the base material such that their edge portions are not connected to the scanning wiring lines.

3. The active matrix substrate according to claim 2,
wherein the line width of the data wiring lines is increased so as to cover unconnected isolation regions between the scanning wiring lines and the edge portions of the light shielding blocks.

4. The active matrix substrate according to claim 1,
wherein the active matrix substrate comprises auxiliary capacitance wiring lines used for generating auxiliary capacitance,
the light shielding blocks are formed on the base material in the same layer and from the same material as the auxiliary capacitance wiring lines, and
the light shielding blocks are provided on the base material such that their edge portions are not connected to the auxiliary capacitance wiring lines.

5. The active matrix substrate according to claim 4, wherein the line width of the data wiring lines is increased so as to cover unconnected isolation regions between the auxiliary capacitance wiring lines and the edge portions of the light shielding blocks.

6. The active matrix substrate according to claim 1,
wherein the active matrix substrate comprises auxiliary capacitance wiring lines used for generating auxiliary capacitance,
the light shielding blocks are formed on the base material in the same layer and from the same material as the scanning wiring lines and the auxiliary capacitance wiring lines, and
the light shielding blocks are provided on the base material such that their edge portions are not connected to the scanning wiring lines and the auxiliary capacitance wiring lines.

7. The active matrix substrate according to claim 6, wherein the line width of the data wiring lines is increased so as to cover unconnected isolation regions between the scanning wiring lines and the edge portions of the light shielding blocks as well as unconnected isolation regions between the auxiliary capacitance wiring lines and the edge portions of the light shielding blocks.

8. The active matrix substrate according to claim 1,
wherein the active matrix substrate comprises auxiliary capacitance wiring lines used for generating auxiliary capacitance,
the light shielding blocks are formed on the base material in the same layer and from the same material as the auxiliary capacitance wiring lines, and
the light shielding blocks are provided on the base material such that their edge portions are connected to the auxiliary capacitance wiring lines.

9. The active matrix substrate according to claim 1, wherein the light shielding blocks are provided on the base material facing the edge portions of the two adjacent pixel electrodes.

10. A display device comprising a display unit, wherein an active matrix substrate according to claim 1 is used in the display unit.
